(19) United States
(12) Patent Application Publication
(10) Pub. No.: US 2025/0389307 A1
(43) Pub. Date: Dec. 25, 2025

(54) ELECTRIC BRAKING DEVICE

(71) Applicant: ADVICS CO., LTD., Kariya-shi, Aichi-ken (JP)

(72) Inventor: Satoshi HIRATA, Kariya-shi, Aichi-ken (JP)

(73) Assignee: ADVICS CO., LTD., Kariya-shi, Aichi-ken (JP)

(21) Appl. No.: 18/995,496

(22) PCT Filed: Aug. 3, 2023
(86) PCT No.: PCT/JP2023/028376

§ 371 Date: Jan. 16, 2025

(30) Foreign Application Priority Data
Aug. 3, 2022 (JP) 2022-123975

(51) Int. Cl. F16D 65/18; F16D 66/00; F16D 121/24; F16D 125/40

(52) U.S. Cl. CPC F16D 65/18; F16D 2066/005; F16D 2121/24; F16D 2125/40

(57) ABSTRACT

An electric braking device is configured that, during assembly of a housing of a caliper section, to which a linear motion conversion mechanism and a load sensor are assembled, to a case, to which a transmission mechanism is assembled, a male terminal installed in the load sensor is inserted in a female terminal installed in the case after an engagement convex section provided to a screw shaft as a rotational section of the linear motion conversion mechanism is engaged with an engagement concave section provided to a third gear as a component of the transmission mechanism.

### TECHNICAL FIELD

The present disclosure relates to an electric braking device.

### BACKGROUND ART

As a caliper-type electric braking device mounted on a vehicle, a device described in PTL 1 has been known. The electric braking device includes an electric motor and a linear motion conversion mechanism. The electric motor generates rotary motion in response to a power supply. The linear motion conversion mechanism converts the rotary motion generated by the electric motor into linear motion. Then, the electric braking device presses a friction member, which interlocks with the linear motion converted by the linear motion conversion mechanism, against a rotary body rotating together with a wheel, and thereby generates a braking force on the wheel. The electric braking device also includes a load sensor that detects a pressing force of the friction member against the rotary body.

### CITATION LIST

### Patent Literature

PTL 1: KR-A-10-2021-0002011

### SUMMARY OF DISCLOSURE

### Technical Problem

As described above, when components are assembled during manufacture of the electric braking device, it is necessary to align and phase a large number of the components. Then, work required for such alignment and phasing can be a factor that hinders improvement in productivity of the electric braking device.

### Solution to Problem

An electric braking device for solving the above problem transmits rotation of an electric motor to a linear motion conversion mechanism by a transmission mechanism, converts rotary motion transmitted by the transmission mechanism from rotary motion of a rotational section into linear motion of a linear motion section in the linear motion conversion mechanism, presses a friction member that interlocks with the linear motion of the linear motion section against a rotary body that rotates together with a wheel, and thereby generates a braking force on the wheel. The electric braking device includes a housing and a case. The housing is provided with: a sensor that detects a pressing load of the friction member on the rotary body; an output terminal that outputs a signal corresponding to the pressing load detected by the sensor; and the linear motion conversion mechanism. In addition, the housing holds the rotational section of the linear motion conversion mechanism to be rotatable. Meanwhile, the case is provided with the transmission mechanism and a circuit board that receives output from the sensor. In addition, the case holds the transmission mechanism to be rotatable. The transmission mechanism is configured to transmit the rotary motion of the electric motor to the rotational section of the linear motion conversion mechanism when being engaged with the rotational section for mechanical meshing therewith. Furthermore, the case or the circuit board is provided with an input terminal that is engaged with the output terminal. The electric braking device is configured that, in assembly of the housing and the case, the output terminal and the input terminal are engaged after engagement between the transmission mechanism and the rotational section.

In the manufacture of the electric braking device, the housing, to which the sensor and the linear motion conversion mechanism are assembled, and the case, to which the transmission mechanism is assembled, are assembled. In addition, during this assembly, the output terminal and the input terminal are engaged, and the rotational section of the linear motion conversion mechanism and the transmission mechanism are engaged. The output terminal and the input terminal have to be phased for the engagement between both of the terminals. The rotational section and the transmission mechanism have to be phased for the engagement between both of those. The electric braking device is configured that, in the assembly of the housing to the case, the output terminal and the input terminal are engaged after the engagement between the rotational section and the transmission mechanism. Thus, the output terminal and the input terminal can be phased in the engaged state between the rotational section and the transmission mechanism. Therefore, the electric braking device has an effect of facilitating assembly work of the housing to the case during manufacturing.

Another electric braking device for solving the above problem transmits rotation of an electric motor to a linear motion conversion mechanism by a transmission mechanism, converts rotary motion transmitted by the transmission mechanism from rotary motion of a rotational section into linear motion of a linear motion section in the linear motion conversion mechanism, presses a friction member that interlocks with the linear motion of the linear motion section against a rotary body that rotates together with a wheel, and thereby generates a braking force on the wheel. The electric braking device includes a housing and a case. The housing is provided with: a sensor that detects a pressing load of the friction member on the rotary body; and the linear motion conversion mechanism. In addition, the housing holds the rotational section of the linear motion conversion mechanism to be rotatable. Meanwhile, the case is provided with the transmission mechanism and a circuit board that receives output from the sensor. In addition, the case holds the transmission mechanism to be rotatable. Furthermore, the housing is provided with an output terminal that is an output terminal electrically connected to the sensor and is one of a male terminal and a female terminal. Meanwhile, the case or the circuit board is provided with an input terminal that is an input terminal electrically connected to the circuit board and is the other of the male terminal and the female terminal corresponding to the output terminal. Then, the sensor and the circuit board are electrically connected by engagement between the output terminal and the input terminal. One of the rotational section and the transmission mechanism is provided with an engagement convex section, and the other is provided with an engagement concave section that is engaged with the engagement convex section. The transmission mechanism is configured to transmit the rotary motion of the electric motor to the rotational section by engagement between the engagement concave section and the engagement convex section. Both of an insertion direction of the male terminal in the female terminal and an insertion direction of the engagement convex section in the engagement concave section are directions parallel to a rotation axis of the rotational section. An insertion amount of the engagement convex section in the engagement concave section is set as a larger amount than an insertion amount of the male terminal in the female terminal.

In the manufacture of the electric braking device, the housing, to which the sensor and the linear motion conversion mechanism are assembled, and the case, to which the transmission mechanism is assembled, are assembled. In addition, during this assembly, the output terminal and the input terminal are engaged, that is, the male terminal is inserted in the female terminal, and the engagement concave section and the engagement convex section are engaged, that is, the engagement convex section is inserted in the engagement concave section. Both of the insertion direction of the male terminal in the female terminal and the insertion direction of the engagement convex section in the engagement concave section are directions parallel to the rotation axis of the rotational section. The insertion amount of the engagement convex section in the engagement concave section is set as the larger amount than the insertion amount of the male terminal in the female terminal. In such an electric braking device, in the assembly of the housing to the case, the output terminal and the input terminal are engaged after a part of the engagement convex section is inserted in the engagement concave section, and the rotational section and the transmission mechanism are engaged. Thus, the output terminal and the input terminal can be phased in the engaged state between the rotational section and the transmission mechanism. Therefore, the electric braking device has the effect of facilitating the assembly work of the housing to the case during manufacturing.

### BRIEF DESCRIPTION OF DRAWINGS

FIG. 1 is a view illustrating a cross-sectional structure of an embodiment of an electric braking device and peripheral components thereof.

FIG. 2 is a cross-sectional view of the electric braking device that is taken along line 2-2 in FIG. 1.

FIG. 3 is a plan view of a load sensor provided to the electric braking device.

FIG. 4 is a plan view of a housing provided to the electric braking device.

FIG. 5 is a perspective view of a female terminal provided to the electric braking device.

FIG. 6 is a perspective view of a tip portion of a screw shaft provided to the electric braking device.

FIG. 7 is a plan view of a third gear provided to the electric braking device.

FIG. 8 is a cross-sectional view of the third gear that is taken along line 8-8 in FIG. 7.

FIG. 9 is a view illustrating a state of a first step of caliper component assembly in a manufacturing process of the electric braking device.

FIG. 10 is a view illustrating a state of a second step of the same component assembly.

FIG. 11 is a cross-sectional view of a caliper section after the same component assembly.

FIG. 12 is a view illustrating a state of a first step of assembly of a caliper and a housing in the manufacturing process of the electric braking device.

FIG. 13 is a view illustrating a state of a second step of the same assembly.

FIG. 14 is a view illustrating a state of a third step of the same assembly.

FIG. 15 is a view illustrating a state during assembly of the caliper section to a case.

FIG. 16 is a view illustrating the state during the assembly of the caliper section to the case.

FIG. 17 is a view illustrating the state during the assembly of the caliper section to the case.

FIG. 18 is a view illustrating the state during the assembly of the caliper section to the case.

### DESCRIPTION OF EMBODIMENTS

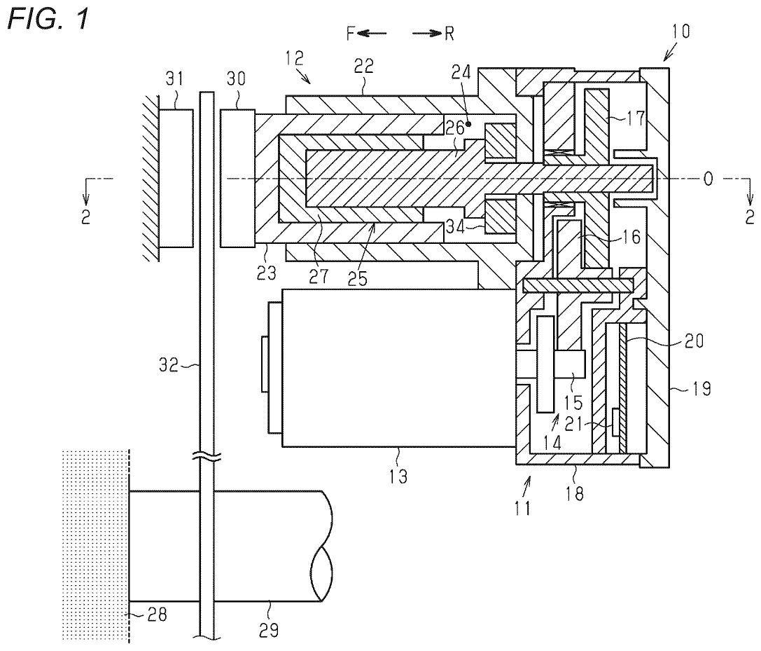

Hereinafter, a description will be made on an embodiment that embodies an electric braking device with reference to FIG. 1 to FIG. 14.

### Configuration of Electric Braking Device

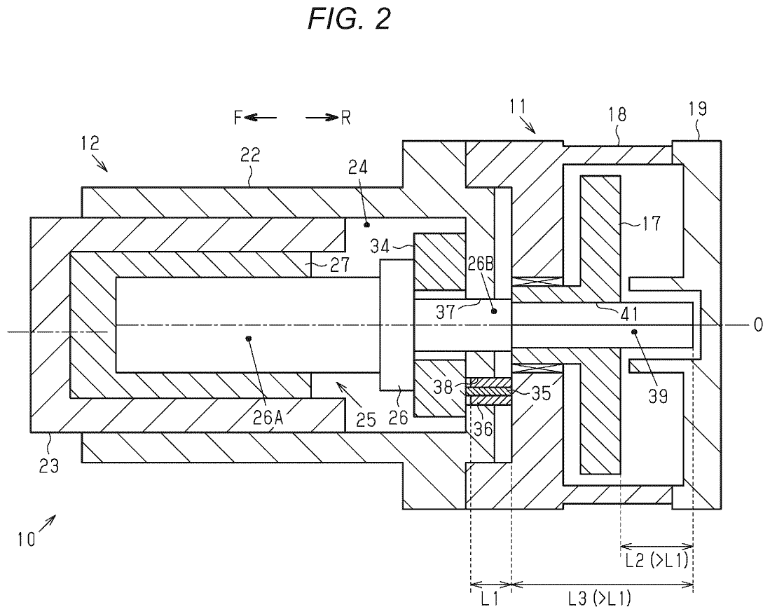

First, a description will be made on a configuration of an electric braking device 10 in this embodiment with reference to FIG. 1 and FIG. 2. FIG. 1 illustrates a cross-sectional structure of the electric braking device 10 and peripheral components thereof. FIG. 2 is a cross-sectional view of the electric braking device 10 that is taken along line 2-2 in FIG. 1. The electric braking device 10 has a drive section 11 and a caliper section 12.

The drive section 11 has an electric motor 13 and a transmission mechanism 14. The transmission mechanism 14 is a mechanism that reduces a speed of rotation of the electric motor 13 and then transmits the rotation thereof. In this embodiment, a reduction gear mechanism that has a first gear 15 coupled to the electric motor 13, a second gear 16 meshing with the first gear 15, and a third gear 17 meshing with the second gear 16 is adopted as the transmission mechanism 14. The electric motor 13 is assembled to a case 18 that is a casing for the drive section 11. In addition, a cover 19 is assembled to the case 18. Then, a storage space for the transmission mechanism 14 is formed by the case 18 and the cover 19. Each of the first gear 15, the second gear 16, and the third gear 17 that constitute the transmission mechanism 14 is rotatably held by the case 18. The drive section 11 also includes a circuit board 20 that includes a CPU 21 as a control section for controlling output of the electric motor 13. In an isolated state from the transmission mechanism 14, the circuit board 20 is stored in the storage space formed by the case 18 and the cover 19.

Meanwhile, the caliper section 12 has a housing 22, a piston 23, and a linear motion conversion mechanism 25. The housing 22 as a casing for the caliper section 12 is assembled to the case 18. The housing 22 has a cylinder 24. The cylinder 24 holds the piston 23 to be slidable. The linear motion conversion mechanism 25 has a rotational section and a linear motion section. Then, the linear motion conversion mechanism 25 converts rotary motion, which is transmitted by the transmission mechanism 14, from rotary motion of the rotational section into linear motion of the linear motion section. In a case of this embodiment, a feed screw mechanism that has a screw shaft 26 as the rotational section and a nut 27 as the linear motion section is adopted as the linear motion conversion mechanism 25. The screw shaft 26 is coupled to the third gear 17 of the transmission mechanism 14 such that the screw shaft 26 is engaged therewith for mechanical meshing and can thereby transmit the rotary motion. Meanwhile, the nut 27 is coupled to the piston 23 in a manner to be able to transmit the linear motion thereto. Here, the linear motion conversion mechanism 25 is assembled to the electric braking device 10 such that a rotation axis of the screw shaft 26 is located on a rotation axis O of the third gear 17. The screw shaft 26 of such a linear motion conversion mechanism 25 is rotatably held by the nut 27. The nut 27 is held in the cylinder 24 via the piston 23. In this way, the screw shaft 26 of the linear motion conversion mechanism 25 is rotatably held in the housing 22 via the nut 27 and the piston 23.

The electric braking device 10 is arranged on a side of a wheel 28 of an automobile. A wheel shaft 29 as a rotational shaft of the wheel 28 is installed such that a brake disc 32 sandwiched by two friction members 30, 31 rotates as one unit. When the piston 23 presses one (the friction member 30) of the two friction members 30, 31, the two friction members 30, 31 are operated in an interlocking manner to reduce a distance therebetween.

Such an electric braking device 10 generates a braking force on the wheel 28 in the following mode. The rotation of the electric motor 13 is decelerated via the first gear 15, the second gear 16, and the third gear 17 of the transmission mechanism 14 and is then transmitted to the screw shaft 26 of the linear motion conversion mechanism 25. In the linear motion conversion mechanism 25, the rotary motion of the screw shaft 26 is converted into linear motion of the nut 27. Then, in conjunction with the linear motion, the friction members 30, 31 press the brake disc 32 to generate the braking force on the wheel 28. In this embodiment, the brake disc 32 corresponds to a rotary body.

In the following description, in the electric braking device 10, a direction that is parallel to the rotation axis O of the third gear 17 will be described as an axial direction. Furthermore, in the axial direction, when seen from the third gear 17, a side on which the nut 27 as a linear motion element of the linear motion conversion mechanism 25 is located will be described as a front side F in the axial direction, and an opposite side thereof will be described as a rear side R in the axial direction.

### Configurations of Load Sensor and Terminal

The electric braking device 10 includes a load sensor 34 that is a sensor for detecting a pressing load applied to the brake disc 32 by the friction members 30, 31. The load sensor 34 is stored in the housing 22. The screw shaft 26 of the linear motion conversion mechanism 25 has a screw section 26A, which is provided with a screw meshing with the nut 27, in a portion thereof on the front side F in the axial direction. The load sensor 34 is arranged in a portion of the cylinder 24 on the rear side R of the screw section 26A in the axial direction.

When the friction members 30, 31 press the brake disc 32, a reaction force thereof is applied to the piston 23. The reaction force applied to the piston 23 is transmitted to the screw shaft 26 via the nut 27. The load sensor 34 is arranged to receive the reaction force that is transmitted to the screw shaft 26. Then, the load sensor 34 is configured to output, as a pressing load detection signal, a signal that corresponds to the reaction force received from the screw shaft 26.

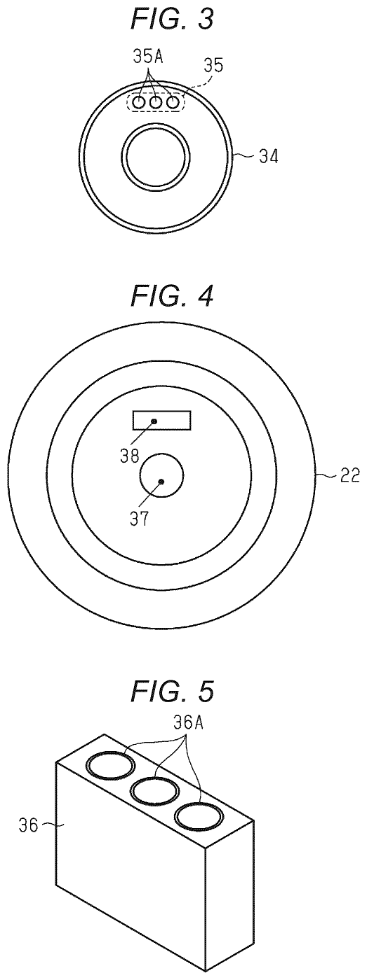

FIG. 3 illustrates a planar structure of the load sensor 34 that is seen from the rear side R in the axial direction. The load sensor 34 has a toroidal columnar shape having a hole, through which the screw shaft 26 is inserted, at a center. In addition, the load sensor 34 has a male terminal 35 that protrudes to the rear side R in the axial direction as an output terminal that outputs the signal corresponding to the pressing load. The male terminal 35 has three plugs 35A, each of which protrudes to the rear side R in the axial direction.

FIG. 4 illustrates a planar structure of the housing 22 that is seen from the front side F in the axial direction. The housing 22 has a shaft hole 37 and a terminal hole 38 in a portion that constitutes a wall surface on the rear side R in the axial direction of the cylinder 24. The shaft hole 37 is a hole through which the screw shaft 26 is inserted, and the terminal hole 38 is a hole through which the male terminal 35 is inserted.

Meanwhile, an input terminal that is engaged with the output terminal of the load sensor 34 is installed in the case 18. In this embodiment, since the male terminal 35 is the output terminal, the input terminal serves as a female terminal 36, into which the male terminal 35 is inserted.

FIG. 5 illustrates a perspective structure of the female terminal 36. The female terminal 36 has three socket holes 36A into which the plugs 35A of the male terminal 35 are respectively inserted. Here, the terminal hole 38 of the housing 22 illustrated in FIG. 4 has a dimensional shape into which the female terminal 36 can be inserted.

As illustrated in FIG. 2, in the electric braking device 10, the load sensor 34 is installed in a state where the male terminal 35 is inserted in the female terminal 36 that is installed in the case 18. In the following description, an insertion amount of the male terminal 35 in the female terminal 36 will be described as a terminal insertion amount L1. In detail, the terminal insertion amount L1 is a length of a portion of each of the plugs 35A of the male terminal 35 that is located inside each of the socket holes 36A of the female terminal 36. An insertion direction of the male terminal 35 in the female terminal 36 is the axial direction.

In the case 18, the female terminal 36 is wired to the circuit board 20. In this way, the pressing load detection signal of the load sensor 34 is input to the CPU 21 of the circuit board 20. Then, the CPU 21 controls the output of the electric motor 13 on the basis of a detection value of the pressing load by the load sensor 34.

### Coupling Structure of Screw Shaft and Third Gear

As described above, the screw shaft 26 of the linear motion conversion mechanism 25 is coupled to the third gear 17 of the transmission mechanism 14 in a manner to be able to transmit the rotary motion. Next, a description will be made on such a coupling structure between the screw shaft 26 and the third gear 17.

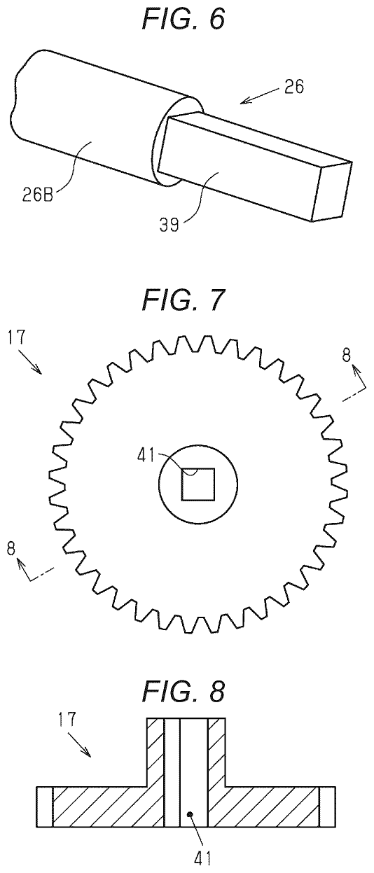

FIG. 6 illustrates a perspective structure of an end portion on the rear side R in the axial direction of the screw shaft 26. As illustrated in FIG. 6, the screw shaft 26 has an engagement convex section 39 having a square columnar shape in the end portion on the rear side R in the axial direction. Here, in the screw shaft 26, a portion between the above-described screw section 26A and the engagement convex section 39 is a shaft section 26B in a columnar shape.

FIG. 7 illustrates a planar structure of the third gear 17 that is seen from the front side F in the axial direction. FIG. 8 illustrates a cross-sectional structure of the third gear 17 that is taken along line 8-8 in FIG. 7. An engagement concave section 41 that has a square columnar shape and with which the engagement convex section 39 of the screw shaft 26 can be engaged is provided at a center of the third gear 17.

As illustrated in FIG. 2, in the electric braking device 10, the screw shaft 26 is assembled in a state where the engagement convex section 39 thereof is engaged with the engagement concave section 41. Then, due to the engagement between the engagement convex section 39 and the engagement concave section 41 in the square columnar shapes, the third gear 17 and the screw shaft 26 are coupled to be able to transmit the rotary motion. In the electric braking device 10, the screw shaft 26 is assembled in a state where a part of the engagement convex section 39 protrudes to the rear side R in the axial direction from the third gear 17. In the following description, a length of a portion of the engagement convex section 39 that protrudes to the rear side R in the axial direction from the third gear 17 will be described as an engagement section protrusion amount L2. In addition, an insertion amount of the engagement convex section 39 in the engagement concave section 41 will be described as an engagement section insertion amount L3. The engagement section insertion amount L3 is a sum of a length of a portion of the engagement convex section 39 located in the engagement concave section 41 and the engagement section protrusion amount L2. In the electric braking device 10 of this embodiment, the length of the engagement convex section 39 is set such that the engagement section protrusion amount L2 is larger than the above-described terminal insertion amount L1. Since the engagement section insertion amount L3 is larger than the engagement section protrusion amount L2, the engagement section insertion amount L3 is also larger than the terminal insertion amount L1.

### Manufacturing Procedure for Electric Braking Device

Next, a description will be made on a manufacturing procedure for the electric braking device 10. In the manufacture of the electric braking device 10, components of the caliper section 12 are assembled, that is, the load sensor 34, the linear motion conversion mechanism 25, and the piston 23 are assembled to the housing 22. Then, the caliper section 12, to which the components have been assembled, is assembled to the case 18.

### Assembly of Components of Caliper Section

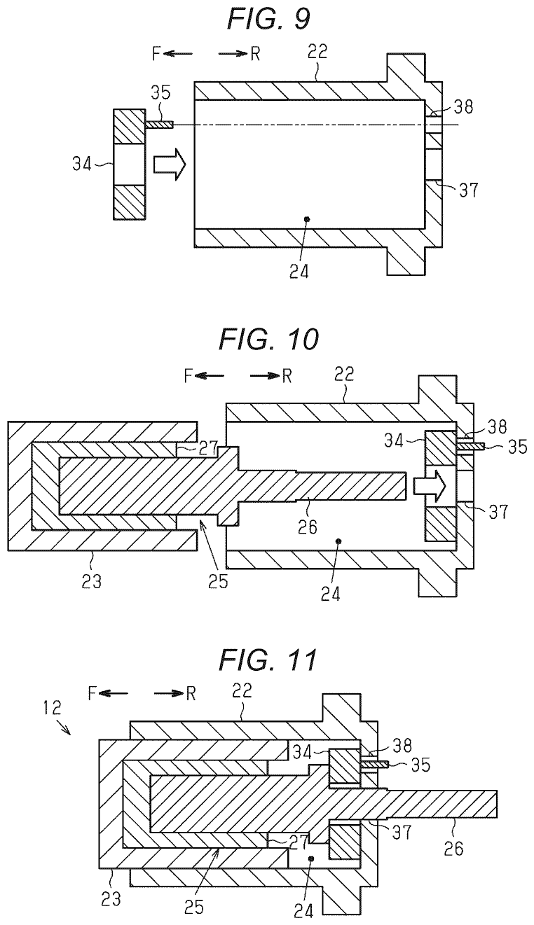

A description will be made on a procedure for assembling the components of the caliper section 12 with reference to FIG. 9 to FIG. 11. The components of the caliper section 12 are assembled in a state where the piston 23 has been assembled to the nut 27 of the linear motion conversion mechanism 25 in advance.

When the components of the caliper section 12 are assembled, first, the load sensor 34 is assembled to the housing 22. As illustrated in FIG. 9, in a state where a tip of the male terminal 35 protrudes to the rear side R in the axial direction through the terminal hole 38, the load sensor 34 is assembled to the innermost portion of the cylinder 24 in the housing 22. The innermost portion of the cylinder 24 is a portion on the rearmost side R in the axial direction of the cylinder 24. The load sensor 34 is desirably installed in the cylinder 24 in a state of restricting rotation about the rotation axis 0 by using a rotation stop component such as a key.

Next, the linear motion conversion mechanism 25 and the piston 23 are assembled to the housing 22, to which the load sensor 34 has been assembled. As illustrated in FIG. 10, in a second step, first, a portion on the rear side R in the axial direction of the screw shaft 26 is inserted in the central hole of the load sensor 34 and the shaft hole 37 of the housing 22. Then, as illustrated in FIG. 11, the linear motion conversion mechanism 25 and the piston 23 are inserted in the cylinder 24 to a position at which the screw section 26A comes into contact with the load sensor 34.

### Assembly of Caliper Section to Case

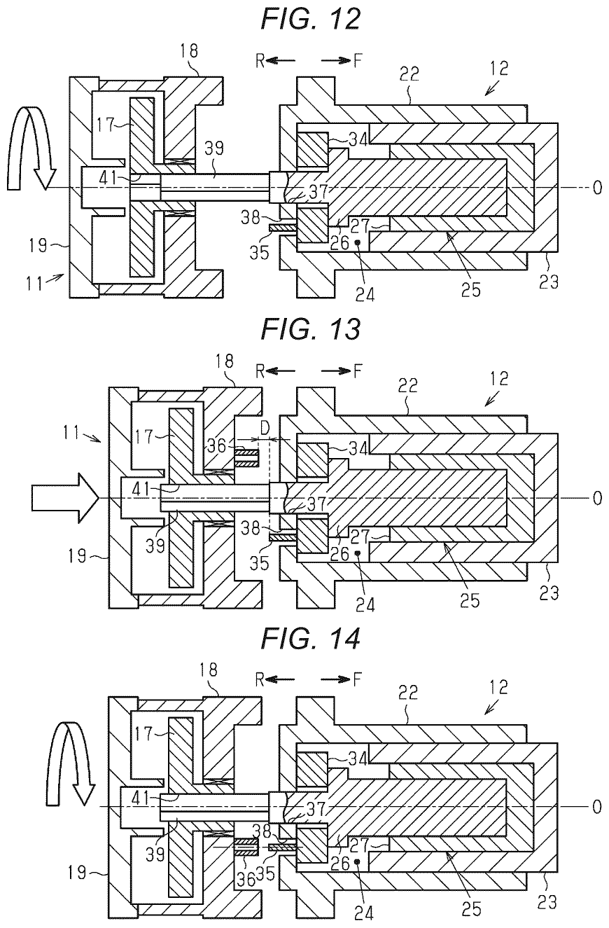

A description will be made on a procedure for assembling the caliper section 12 to the case 18 with reference to FIG. 12 to FIG. 14. The caliper section 12 is assembled in a state where the first gear 15, the second gear 16, and the third gear 17 of the transmission mechanism 14 and the female terminal 36 have been assembled to the case 18 in advance. The electric motor 13, the cover 19, and the circuit board 20 may be assembled to the case 18 either before or after the assembly of the caliper section 12.

In addition, in this embodiment, assembly work is performed in a state where the caliper section 12 is fixed and the case 18 is held as follows. That is, the above state is a state where the rotation axis O of the third gear 17 is maintained to be located on the rotation axis of the screw shaft 26, and a state where the case 18 can rotate about the rotation axis O and can be moved linearly in the axial direction.

During the assembly of the caliper section 12 to the case 18, first, as illustrated in FIG. 12, the case 18 is moved in the axial direction until a distance between the engagement convex section 39 of the screw shaft 26 and the engagement concave section 41 is reduced to some extent. Then, the engagement convex section 39 and the engagement concave section 41 are phased. That is, the case 18 is rotated such that a rotational phase of the engagement convex section 39 about the rotation axis O becomes a phase in which the engagement convex section 39 can be inserted in the engagement concave section 41.

Next, as illustrated in FIG. 13, the case 18 is moved to the front side F in the axial direction until a part of the engagement convex section 39 is inserted in the engagement concave section 41. Meanwhile, “D” in FIG. 13 indicates an inter-terminal distance that is a distance between the male terminal 35 and the female terminal 36 in the axial direction. At this point, the case 18 is not moved to the front side F in the axial direction of a position at which the inter-terminal distance D becomes “0”.

Next, as illustrated in FIG. 14, the male terminal 35 and the female terminal 36 are phased. That is, the case 18 is rotated such that a rotational phase of the male terminal 35 about the rotation axis O becomes a phase in which the male terminal 35 can be inserted in the female terminal 36.

Thereafter, the case 18 is moved to a position at which the case 18 abuts the housing 22. This movement causes the male terminal 35 to be inserted in the female terminal 36. In the case where the case 18 and the housing 22 are fixed to each other by bolting or the like, fixing work thereof is performed. As described so far, the assembly of the caliper section 12 to the case 18 is completed.

### Operation and Effects of Embodiment

A description will be made on operation and effects of the electric braking device 10 in this embodiment that has been configured as described so far.

As described above, in the manufacturing process of the electric braking device 10, the caliper section 12 is assembled to the case 18. In the assembling process of the caliper section 12 to the case 18, the engagement convex section 39 of the screw shaft 26 is engaged with the engagement concave section 41 of the third gear 17, and the male terminal 35 of the load sensor 34 is inserted in the female terminal 36 installed in the case 18. Accordingly, when the caliper section 12 is assembled to the case 18, it is necessary to phase the engagement concave section 41 and the engagement convex section 39 and to phase the male terminal 35 and the female terminal 36.

Such assembly of the caliper section 12 to the case 18 can also be performed by the following procedure, for example. First, both of a pair of the engagement concave section 41 and the engagement convex section 39 and a pair of the male terminal 35 and the female terminal 36 are phased. Then, while such a state is maintained, both of the caliper section 12 and the case 18 are displaced relative to each other in the axial direction and then assembled.

Here, in the rotatably held state, the third gear 17, which is provided with the engagement concave section 41, is installed in the case 18. Similarly, in the rotatably held state, the screw shaft 26, which is provided with the engagement convex section 39, is also installed in the housing 22. Accordingly, in order to set a state where the engagement concave section 41 and the engagement convex section 39 are phased and the male terminal 35 and the female terminal 36 are phased, it is necessary to rotate the screw shaft 26 and the third gear 17 and adjust the rotational phases thereof. In addition, it is necessary to fix the screw shaft 26 and the third gear 17 in a non-rotatable manner in order to prevent shifting of the phases during the assembly work.

On the contrary, in the electric braking device 10 of this embodiment, during the assembly of the caliper section 12 to the case 18, after the engagement convex section 39 and the engagement concave section 41 are phased, and those are engaged, the male terminal 35 and the female terminal 36 can be phased. Accordingly, the caliper section 12 can be assembled to the case 18 while the engagement convex section 39 and the engagement concave section 41 are phased, and the male terminal 35 and the female terminal 36 are phased. Thus, the assembly work of the caliper section 12 to the case 18 is facilitated. Here, at least one of the engagement convex section 39 and the engagement concave section 41 may be chamfered. Since some phase shift can be absorbed by chamfering, phasing can be facilitated.

### Dimensional Requirements for Components of Electric Braking Device

As described above, in the case where the male terminal 35 and the female terminal 36 can be phased in the engaged state between the engagement convex section 39 and the engagement concave section 41, the assembly work of the caliper section 12 to the case 18 is facilitated. Dimensional requirements for the components of the electric braking device 10 that enable such assembly work will be discussed.

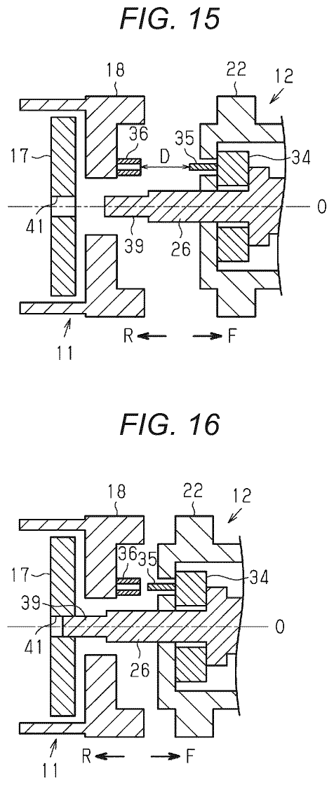

Here, such a case is considered that, as illustrated in FIG. 15, the caliper section 12 is assembled to the case 18 by reducing a distance between the caliper section 12 and the case 18 in the axial direction while maintaining the state where the rotation axis of the screw shaft 26 is located on the rotation axis O of the third gear 17. As illustrated in FIG. 16, in the case where the engagement convex section 39 is engaged with the engagement concave section 41 in a state where the inter-terminal distance D is longer than 0, the male terminal 35 and the female terminal 36 can be phased after the engagement between the engagement convex section 39 and the engagement concave section 41. In the following description, phasing between the male terminal 35 and the female terminal 36 after the engagement between the engagement convex section 39 and the engagement concave section 41 will be described as post-engagement terminal phasing.

Meanwhile, in a state where the inter-terminal distance D is longer than 0, post-engagement terminal phasing cannot be performed unless the engagement convex section 39 is engaged with the engagement concave section 41. Thus, a condition under which post-engagement terminal phasing can be performed is that the engagement convex section 39 is in the engaged state with the engagement concave section 41 at a time point when the inter-terminal distance D becomes 0.

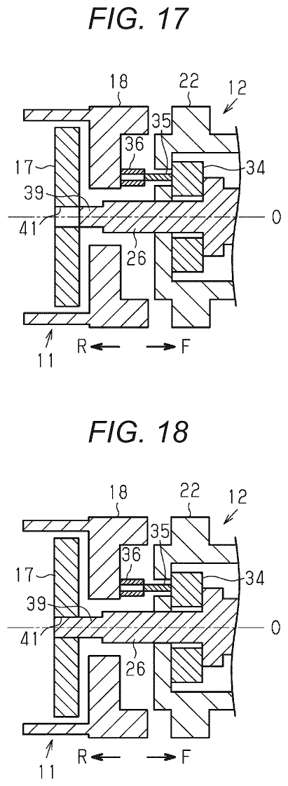

As illustrated in FIG. 17, such a case is considered that the engagement between the engagement convex section 39 and the engagement concave section 41 is started at the same time as when the inter-terminal distance D becomes 0. This state is a boundary state that determines whether post-engagement terminal phasing can be performed. In this case, the terminal insertion amount L1 and the engagement section insertion amount L3 become an equal amount at a time point when the assembly is completed. Thus, when the dimensions of the components of the electric braking device 10 are set to increase the engagement section insertion amount L3 to be larger than the terminal insertion amount L1, post-engagement terminal phasing can be performed.

In the case where the male terminal 35 and the female terminal 36 are phased in a state where the engagement convex section 39 is engaged with only a part of the engagement concave section 41, there is a possibility that the engagement convex section 39 is disengaged from the engagement concave section 41 during the work. Thus, the male terminal 35 and the female terminal 36 are desirably phased in a state where the engagement convex section 39 is engaged with the entire engagement concave section 41.

As illustrated in FIG. 18, such a case is considered that the engagement convex section 39 is engaged with the entire engagement concave section 41 when the inter-terminal distance D becomes exactly 0. This state is a boundary state that determines whether the male terminal 35 and the female terminal 36 can be phased in the state where the engagement convex section 39 is engaged with the entire engagement concave section 41. In this case, the terminal insertion amount L1 and the engagement section protrusion amount L2 become an equal amount at the time point when the assembly is completed. Thus, when the dimensions of the components of the electric braking device 10 are set to increase the engagement section protrusion amount L2 to be larger than the terminal insertion amount L1, the male terminal 35 and the female terminal 36 can be phased in the state where the engagement convex section 39 is engaged with the entire engagement concave section 41.

### Other Embodiments

This embodiment can be modified and implemented as follows. This embodiment and each of the following modified examples can be implemented in combination with each other unless technically contradictory.
The caliper section 12 may be assembled to the case 18 in a state where the case 18 is fixed and the caliper section 12 is held to be rotatable and movable in the axial direction. Alternatively, such assembly may be performed in a state where one of the case 18 and the caliper section 12 is held to be rotatable and the other is held to be movable in the axial direction. Further alternatively, such assembly may be performed in a state where both of the case 18 and the caliper section 12 are held to be rotatable and movable in the axial direction.
The female terminal 36 may be installed on the circuit board 20.
The female terminal 36 may be installed on the load sensor 34, and the male terminal 35 may be installed on the case 18 or the circuit board 20.
Shapes of the male terminal 35 and the female terminal 36 can be changed appropriately. In short, any shape can be adopted as long as the female terminal 36 and the male terminal 35 are electrically connected by insertion of the male terminal 35 in the female terminal 36.
The linear motion conversion mechanism 25 may be configured that the nut 27 serves as the rotational section and the screw shaft 26 serves as the linear motion section. In such a case, the engagement convex section 39 is provided to the nut 27 as the rotational section.
The engagement concave section 41 may be provided to the rotational section of the linear motion conversion mechanism 25, and the engagement convex section 39 may be provided on the transmission mechanism 14 side.
The engagement convex section 39 and the engagement concave section 41 may each have a shape other than the square columnar shape as long as having a shape capable of transmitting the rotary motion through the engagement.
The number of the gears in the transmission mechanism 14 may be changed. In addition, a mechanism other than the reduction gear mechanism, such as a winding transmission mechanism, may be adopted as the transmission mechanism 14.
A drum-shaped rotary body may be used as the rotary body that is pressed by the friction members 30, 31.

1. An electric braking device that transmits rotation of an electric motor to a linear motion conversion mechanism by a transmission mechanism, converts rotary motion transmitted by the transmission mechanism from rotary motion of a rotational section into linear motion of a linear motion section in the linear motion conversion mechanism, presses a friction member that interlocks with the linear motion of the linear motion section against a rotary body that rotates together with a wheel, and thereby generates a braking force on the wheel, the electric braking device comprising:
a housing that is provided with a sensor, an output terminal, and the linear motion conversion mechanism and holds the rotational section of the linear motion conversion mechanism to be rotatable, the sensor detecting a pressing load of the friction member on the rotary body, and the output terminal outputting a signal corresponding to the pressing load detected by the sensor; and
a case that is provided with the transmission mechanism and a circuit board receiving output from the sensor and holds the transmission mechanism to be rotatable, wherein
the transmission mechanism transmits the rotary motion of the electric motor to the rotational section when being engaged with the rotational section for mechanical meshing,
the case or the circuit board is provided with an input terminal that is engaged with the output terminal, and
the electric braking device is configured that, in assembly of the housing and the case, the output terminal and the input terminal are engaged after engagement between the transmission mechanism and the rotational section.

2. An electric braking device that transmits rotation of an electric motor to a linear motion conversion mechanism by a transmission mechanism, converts rotary motion transmitted by the transmission mechanism from rotary motion of a rotational section into linear motion of a linear motion section in the linear motion conversion mechanism, presses a friction member that interlocks with the linear motion of the linear motion section against a rotary body that rotates together with a wheel, and thereby generates a braking force on the wheel, the electric braking device comprising:
a housing that is provided with a sensor and the linear motion conversion mechanism and holds the rotational section of the linear motion conversion mechanism to be rotatable, the sensor detecting a pressing load of the friction member on the rotary body; and
a case that is provided with the transmission mechanism and a circuit board receiving output from the sensor and holds the transmission mechanism to be rotatable, wherein
the housing is provided with an output terminal that is an output terminal electrically connected to the sensor and is one of a male terminal and a female terminal,
the case or the circuit board is provided with an input terminal that is an input terminal electrically connected to the circuit board and is the other of the male terminal and the female terminal corresponding to the output terminal,
the sensor and the circuit board are electrically connected by engagement between the output terminal and the input terminal,
one of the rotational section and the transmission mechanism is provided with an engagement convex section, and the other is provided with an engagement concave section that is engaged with the engagement convex section,
the transmission mechanism transmits the rotary motion of the electric motor to the rotational section by engagement between the engagement concave section and the engagement convex section,
both of an insertion direction of the male terminal in the female terminal and an insertion direction of the engagement convex section in the engagement concave section are directions parallel to a rotation axis of the rotational section, and
an insertion amount of the engagement convex section in the engagement concave section is set as a larger amount than an insertion amount of the male terminal in the female terminal.

3. The electric braking device according to claim 2, wherein
a portion on a tip side of the engagement convex section protrudes from the engagement concave section, and a protrusion amount of the portion on the tip side of the engagement convex section from the engagement concave section is set to be larger than the insertion amount of the male terminal in the female terminal.
